(19) United States
(12) Patent Application Publication
(10) Pub. No.: US 2025/0323266 A1
(43) Pub. Date: Oct. 16, 2025

(54) HIGH-VOLTAGE, HIGH-POWER BATTERIES WITH DUAL-REDOX-CENTER FERROCENE-BASED ORGANIC CATHODE

(71) Applicant: City University of Hong Kong, Hong Kong (HK)

(72) Inventors: Chunyi ZHI, Hong Kong (HK); Pei LI, Hong Kong (HK); Jiaxiong ZHU, Hong Kong (HK)

(21) Appl. No.: 18/637,408

(22) Filed: Apr. 16, 2024

(51) Int. Cl. H01M 4/60; C07F 17/02; H01M 4/02; H01M 4/13; H01M 4/62; H01M 4/66; H01M 4/74; H01M 10/0568; H01M 10/0569

(52) U.S. Cl. CPC H01M 4/60; H01M 4/13; H01M 4/623; H01M 4/625; H01M 4/663; H01M 4/747; H01M 10/0568; H01M 10/0569; C07F 17/02; H01M 2004/028; H01M 2300/0042

(57) ABSTRACT

A high-voltage, high-power battery for efficient energy storage and delivery is provided. It includes at least one anode crafted from lithium metal or zinc metal, paired with an organic cathode featuring an active material, specifically (ferrocenylmethyl) trimethylammonium iodide (FcNI), a ferrocene backbone introduced with methyltrimethylammonium iodide groups, denoted by formula (1):

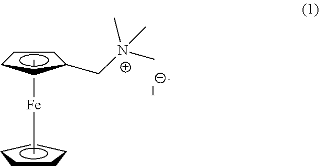

The battery also includes at least one porous polymer separator, characterized by a porosity ranging from approximately 30% to 90%, facilitating ion transport while maintaining structural integrity. Furthermore, the battery incorporates an ether electrolyte, enabling optimal electrochemical performance. It is worth noting that the introduced methyltrimethylammonium iodide groups enhances the redox activity of Fe^{3+/2+} and acts as active dual-redox centers for multiple electron transfer. Particularly, Fe^{3+/2+}'s discharging plateau is enhanced to 0.8 V by introducing the methyltrimethylammonium iodide groups, which regulates the electron energy of the redox potential of Fe.

### FIELD OF THE INVENTION

The present invention generally relates to battery materials. More specifically the present invention relates to high-voltage, high-power batteries with dual-redox-centered ferrocene-based organic cathodes.

### BACKGROUND OF THE INVENTION

Advanced battery technologies are a focal point in addressing the escalating demand for large-scale battery systems and intelligent renewable energy grids. Organic electrode materials, in particular, stand out for their abundant natural resources, minimal environmental impact, and efficient mass producibility compared to inorganic metal oxides. The unique synthetic design capabilities of organic compounds, with molecular-level engineering of their structures, empower their electrodes with diverse energy storage capacities.

However, progress has been hindered by challenges in incorporating high-electron-density redox couples into stable materials that support high voltage output and fast charge transport. Typically, organic cathodes suffer from low capacity (mostly <200 mAh g⁻¹ at low rate) and low discharge voltage (mostly <1 V vs. Zn/Zn²⁺), a result of low redox activity, limited electron transfer number and inherent low redox potential related to Fermi energies, which all lead to low-energy-density batteries. Another challenge facing organic electrodes is the unimpressive power capability due to the slow intrinsic redox kinetics and low conductivity of organic molecules.

One noteworthy organic material is ferrocene (Fc, Fe(C₅H₅)₂), an organometallic complex renowned for winning the 1973 Nobel Prize due to its pivotal role in the chemistry of organometallic sandwich compounds. Derived from two cyclopentadienyl rings bound to a central Fe atom, ferrocene and its derivatives have garnered extensive attention, leveraging the high abundance and cost-effectiveness of iron. In contrast to conventional p-type, n-type, and bipolar-type organic cathode materials, ferrocene uniquely relies on a reversible Fe^{3+/2+} redox process. While it has found applications in flow batteries when dissolved in electrolyte as catholyte, its broader use in static batteries faces significant challenges.

The primary issues revolve around the unsatisfactory redox potential (0.4 V vs. SHE) and low capacity (144 mAh g⁻¹ in theory), limiting its appeal as a cathode material. These limitations stem from constrained electron transfer and the intrinsically low redox potential associated with Fermi energies. Additionally, ferrocene's thermodynamic instability, leading to sublimation at room temperature, complicates conventional cathode preparation methods and necessitates the introduction of stabilizing agents, restricting its capacity further. Despite tunability, molecular modifications have shown limited activity improvement, often accompanied by increased molecular weight and the risk of lowering the already unsatisfactory redox potential. Consequently, reports on electroactive ferrocene-based molecules in batteries have been scarce and largely unsuccessful.

Addressing this issue, the present invention focuses on designing electroactive ferrocene-based molecules characterized by high activity, abundant redox-active sites, and elevated voltage output. This invention responds to the challenging yet crucial need for efficient and effective ferrocene-based materials in battery applications.

### SUMMARY OF THE INVENTION

It is an objective of the present invention to provide device and material, or metho to solve the aforementioned technical problems.

In accordance with a first aspect of the present invention, a high-voltage, high-power battery is provided. Particularly, the battery includes at least one anode having one or more materials selected from lithium metal or zinc metal; at least one organic cathode having an active material including a (ferrocenylmethyl) trimethylammonium iodide (FcNI) with formula (1):

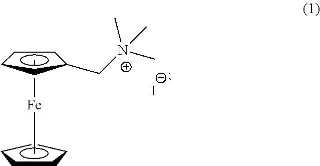

at least one porous polymer separator having a porosity from approximately 30% to 90%; and an ether electrocyte.

In accordance with one embodiment of the present invention, the FcNI is a ferrocene backbone introduced with methyltrimethylammonium iodide groups.

In accordance with one embodiment of the present invention, the introduced methyltrimethylammonium iodide groups enhances the redox activity of Fe^{3+/2+} and acts as active dual-redox centers for multiple electron transfer.

It is worth noting that discharging plateau of Fe^{3+/2+} is greatly enhanced, for instance, an increasement of 0.5-1.0 V) due to introduction of methyltrimethylammonium iodide groups, which regulates the electron energy related to the redox potential of Fe.

In accordance with one embodiment of the present invention, the battery has a maximum working voltage of 3.5V when the at least one anode including Li metal material.

In accordance with one embodiment of the present invention, the battery has a maximum working voltage of 1.7V when the at least one anode including Zn metal material.

In accordance with one embodiment of the present invention, the at least one organic cathode is prepared by mixing the FcNI, an electrically conductive particle and a binder in a solvent to obtain a mixture, and coating the mixture on a current collector with a subsequent drying process conducted at 40-70° C. in a vacuum oven for at least 24 hours.

In accordance with one embodiment of the present invention, the current collector is selected from a carbon cloth, a carbon paper, a graphite paper, a Ti foil/mesh, or a stainless steel stabled with high voltage and high valence state iodine.

In accordance with one embodiment of the present invention, the solvent is selected from monoglyme, diglyme, triglyme, or tetraglyme.

In accordance with one embodiment of the present invention, the electrically conductive particle is selected from a reduced graphene oxide, an activated carbon, a hollow carbon sphere, or a carbon cloth.

In accordance with one embodiment of the present invention, the binder is selected from styrene-butadiene rubber (SBR) or polyvinylidene fluoride (PVDF).

In accordance with one embodiment of the present invention, the ether electrocyte is an ether solvent with or without an additive. the ether solvent is selected from monoglyme, diglyme, triglyme, tetraglyme, or a combination thereof in a volume ratio of 1:1/1:2/1:3/1:4.

In accordance with one embodiment of the present invention, the additive is selected from saccharin, vanillin, sorbitol, or aromatic analogs.

In accordance with one embodiment of the present invention, the additive includes C═O, —F, —O— or —SO3 radicals when the at least one anode having Zn metal material; and the additive includes LiF, LiNO3, vinylene carbonate (VC), vinyl ethylene carbonate, allyl ethyl carbonate, or lithium bis(oxalato) borate when the at least one anode having Li metal material.

In accordance with one embodiment of the present invention, the ether electrocyte includes Zn/Li salts.

In accordance with one embodiment of the present invention, the Zn salts are selected from Zn(TFSI)₂, Zn(FSI)₂, Zn(OTF)₂, Zn(ClO₄)₂, ZnAc₂, ZnCl₂, or Zn(PF₆)₂

In accordance with one embodiment of the present invention, the Li salts are selected from LiTFSI, LiOTF, LiPF₆, LiClO₄, LiBF₄, LiAsF₆, LiDFOB.

### BRIEF DESCRIPTION OF THE DRAWINGS

Embodiments of the invention are described in more details hereinafter with reference to the drawings, in which:

FIGS. 1A-1G depict the synthetic design and the features of FcNI, in which FIG. 1A schematically depict a synthetic process of FcNI, FIG. 1B depicts the ¹H NMR spectra of FcNI, FIG. 1C schematically shows the molecular structure of FcNI, FIG. 1D depicts the density-functional theory calculation on LUMO and HOMO of FcNI, Fc, I₂, FIG. 1E shows the calculated Gibbs free energy by DFT, FIG. 1F shows the optimized charge-density-difference patterns, and FIG. 1G depicts the predicted reaction pathway;

FIGS. 2A-2D depict the characteristics of FcNI, in which FIG. 2A displays a scanning electron microscopy (SEM) image of FcNI, FIG. 2B depicts the energy dispersive spectroscopy (EDS) mapping analysis, FIG. 2C shows the fourier transform infrared spectra of FcNI, and FIG. 2D demonstrates the UV-vis absorption results of FcNI;

FIGS. 3A-3B respectively shows the 1H-NMR spectroscopy of FcNI (FIG. 3A) and Fc (FIG. 3B) in dimethyl sulfoxide;

FIG. 4 depicts the electrostatic potential analysis of FcNI;

FIGS. 5A-5G depict the enhanced voltage and redox mechanism of FcNI revealed by in-situ Raman and ex-situ XPS characterization, in which FIG. 5A shows the cyclic voltammograms of Fc, I₂ and FcNI with zinc anode at 2 mV s⁻¹ and their chemical structures, FIG. 5B is a voltage profile showing two discharge plateaus and enhanced voltage, FIG. 5C is a schematic diagram showing the electronic density of states and Fermi energies for cathodes (E_{FA} is the Fermi energy of the anode and SEI stands for solid electrolyte interphase), FIG. 5D depicts the charge and discharge curves in the voltage range of 0.6 to 2 V at 0.3 A g⁻¹, FIG. 5E depicts the evolution of I₃⁻ bands during galvanostatic charge/discharge measurements, FIG. 5F depicts the I₃⁻ obtained ex-situ at various charging states, and FIG. 5G depicts the Fe 2p obtained ex-situ at various charging states;

FIGS. 6A-6C respectively show the survey XPS spectra of FcNI at discharging states of 0.6V (FIG. 6A), 1.3V (FIG. 6B) and 2.0V (FIG. 6C);

FIGS. 7A-7G depict the cell performance and comparison of Zn-FcNI, in which FIG. 7A shows the galvanostatic charge/discharge profiles of the Zn-FcNI full cell at different current densities, FIG. 7B displays the discharge capacities at different rates, FIG. 7C shows the capacity contribution of each discharge plateau under different charging/discharging rates, FIG. 7D shows the specific capacity under different charging/discharging rates at every plateau, FIG. 7E displays the cycling performance and coulombic efficiency at a current density of 5 A g⁻¹ with the insets showing the voltage profiles of the first 10 cycles, FIG. 7F depicts the voltage profiles of the cell during the last 10 cycles of 5000 cycles (bi-plateau is remained during the whole cycling), and FIG. 7G depicts the gravimetric energy densities, voltage and cycling number comparison of Zn-FcNI cells (star, based on mass of active center or the total mass) with existing Zn batteries using organic cathodes (circle), manganese oxides (rectangle), Prussian blue analogues (triangle), vanadium-based materials (inverted triangle), chevrel phase Mo₆S₈ (hexagon);

FIGS. 8A-8E depict the full cell performance of Li-FcNI, in which FIG. 8A depicts a CV curve of a Li-FcNI full cell at different scan rates from 0.2 to 0.5 mV s⁻¹ (upper panel) and 2 to 10 mV s⁻¹ (bottom panel), FIG. 8B shows the galvanostatic charge/discharge profiles of the Li-FcNI full cell at different current densities, FIG. 8C demonstrates the comparison of operation voltage and occurrence on the Earth's crust among various conversion-type cathodes for Li batteries, FIG. 8D depicts the discharge capacities at different rates, and FIG. 8E shows the long-term cycling performance at 1 A g⁻¹;

FIG. 9 depicts the energy density versus power density of the organic Zn-FcNI cell and Li-FcNI cell based on the mass of FcNI cathode;

FIGS. 10A-10B show the cyclic voltammetry (CV) curves of Zn-FcNI and Li-FcNI cell at different scan rates from 0.2 to 0.5 mV (upper panel), 2 to 10 mV s⁻¹ (middle panel) and 20 to 50 mV s⁻¹ (bottom panel), in which FIG. 10 A directs to Zn-FcNI cell and FIG. 10B relates to Li-FcNI cell;

FIGS. 11A-11F depicts the characteristics of fast kinetics of FcNI, in which FIG. 11A and FIG. 11B respectively show the log (peak current) versus log (scan rate) plot of the cathodic and anionic current responses at I redox and Fe redox in a Zn-FcNI (FIG. 11A) and Li-FcNI cell (FIG. 11B), FIG. 11C and FIG. 11D respectively display the capacity contribution at different scan rates of the Zn-FcNI (FIG. 11C) and Li-FcNI cell (FIG. 11D), FIG. 11E depicts the AC-impedance spectra with the right side showing the corresponding equivalent circuit model, and FIG. 11F shows the distribution of relaxation time (DRT) plots at different voltages with an inset displaying a close-up view at shorter relaxation time; and

FIG. 12 shows the DRT plots at different voltages (10⁻⁶ s<τ<10s).

### DETAILED DESCRIPTION

In the following description, high-voltage, high-power batteries and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The term “active material” of an electrode used herein refers a material contributing directly to the electrode reaction including the charging reaction and the discharging reaction, and performs a major function of a battery system.

An anode as used herein refers to an electrode through which electric charge flows into a polarized electrical device. From an electrochemical point of view, negatively-charged anions move toward the anode and/or positively-charged cations move away from it to balance the electrons arriving from external circuitry. In a discharging battery, the anode is the negative terminal where electrons flow out. If the anode is composed of a metal, electrons that it gives up to the external circuit are accompanied by metal cations moving away from the electrode and into the electrolyte.

An organic cathode, as referred to herein, denotes an electrode within an electrical device that serves as the site where electric charge flows out of the device. From an electrochemical standpoint, in the context of batteries or other polarized electrical systems, positively charged cations typically migrate towards the organic cathode, while negatively charged anions move away from it, thus maintaining charge balance as electrons flow through the external circuitry. In the context of a discharging battery, the organic cathode functions as the positive terminal, aligning with the direction of conventional current. Internally, this outward flow of charge is facilitated by the movement of positive ions from the electrolyte towards the organic cathode, contributing to the overall electrochemical processes occurring within the device.

In accordance with a first aspect of the present invention, a high-voltage, high-power battery aimed at optimizing energy storage efficiency and overall performance is provided.

Comprising at least one anode constructed from lithium metal or zinc metal, and at least one organic cathode containing an active material, specifically (ferrocenylmethyl) trimethylammonium iodide (FcNI), this battery delivers exceptional power output and voltage stability. The FcNI compound, characterized by its unique ferrocene backbone with methyltrimethylammonium iodide groups, serves as an efficient redox mediator within the cathode, facilitating multiple electron transfer and enhancing the redox activity of Fe^{3+/2+}. This enhancement extends the discharging plateau of Fe^{3+/2+} with an increasement of 0.5-1.0 V, effectively regulating the electron energy of the redox potential of iron. The battery also includes a porous polymer separator with optimized porosity ranging from approximately 30% to 90%, ensuring efficient ion transport between the anode and cathode. Additionally, an ether electrolyte is incorporated to promote ion conductivity and overall battery performance. It is worth noting that the compound satisfies formula (1):

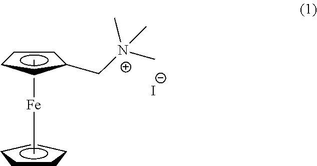

In some embodiments, when utilizing lithium metal as the anode material, the battery achieves a maximum working voltage of 3.5V, while with zinc metal, the maximum working voltage is 1.7V, showcasing its versatility across different metal compositions.

The organic cathode is prepared by blending FcNI with an electrically conductive particle and a binder in a solvent, which is subsequently coated onto a current collector and dried at 40-70° C. in a vacuum oven. The current collector options include carbon cloth, carbon paper, graphite paper, Ti foil/mesh, or stainless steel stabilized with high-valence-state chlorine, ensuring compatibility with various battery configurations. The solvent options include monoglyme, diglyme, triglyme, or tetraglyme, while the electrically conductive particles encompass reduced graphene oxide, activated carbon, hollow carbon spheres, or carbon cloth. Binders such as styrene-butadiene rubber (SBR) or polyvinylidene fluoride (PVDF) further enhance the stability and adhesion of the cathode material.

The ether electrolyte, including an ether solvent with or without additives, contributes to the overall performance and safety of the battery. Ether solvents like monoglyme, diglyme, triglyme, or tetraglyme are combined in various volume ratios, while additives such as saccharin, vanillin, sorbitol, or aromatic analogs provide additional stability and ion conductivity. Depending on the composition of the anode material, specific additives are selected to optimize battery performance and longevity. For zinc-based anodes, additives containing C═O, —F, —O—, or —SO₃ radicals are utilized, while lithium-based anodes benefit from additives like LiF, LiNO₃, vinylene carbonate (VC), vinyl ethylene carbonate, allyl ethyl carbonate, or lithium bis(oxalato) borate. Moreover, the ether electrolyte may include Zn/Li salts, such as Zn(TFSI)₂, Zn(FSI)₂, Zn(OTF)₂, Zn(ClO₄)₂, ZnAc₂, ZnCl₂, LiTFSI, LiOTF, LiPF₆, LiClO₄, LiBF₄, LiAsF₆, or LiDFOB, to further enhance battery performance and stability.

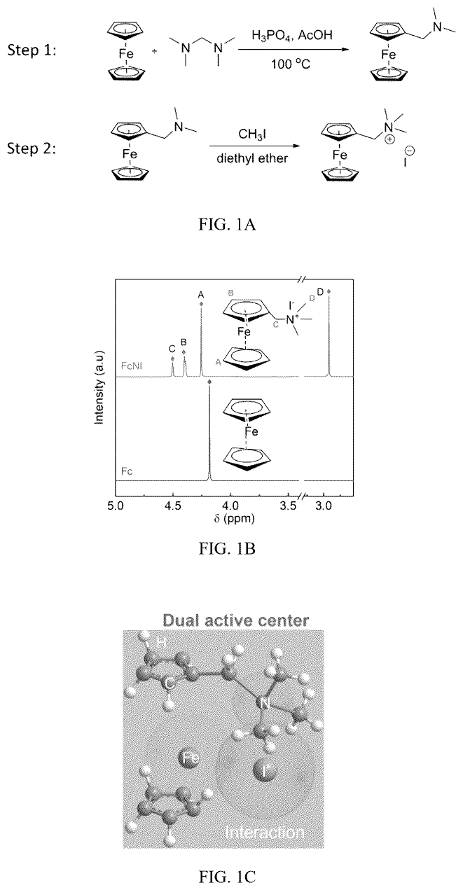

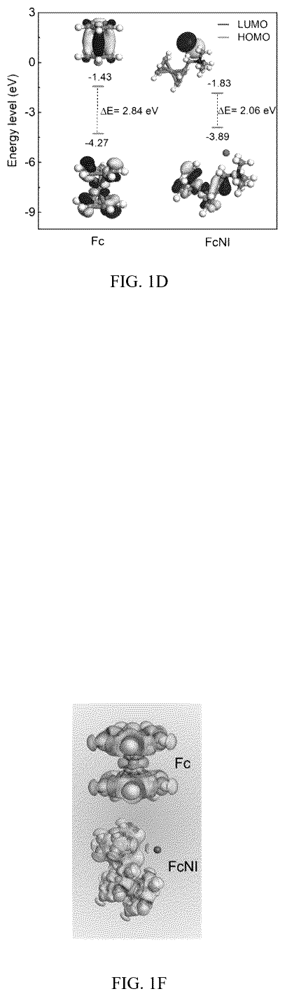

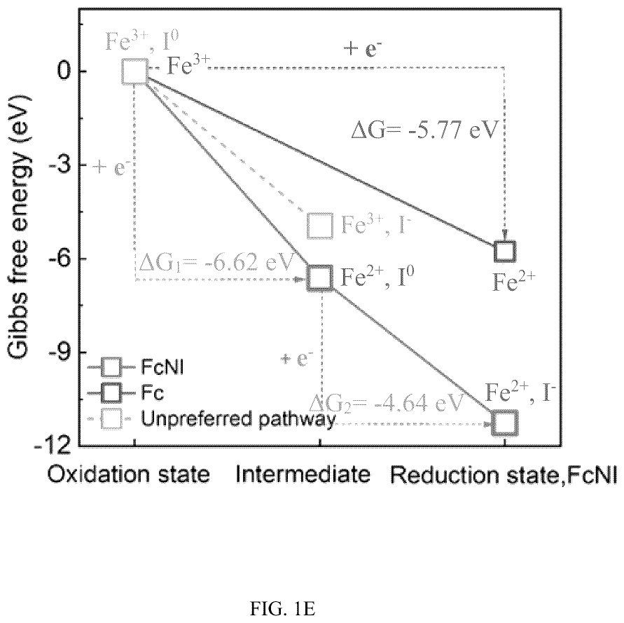

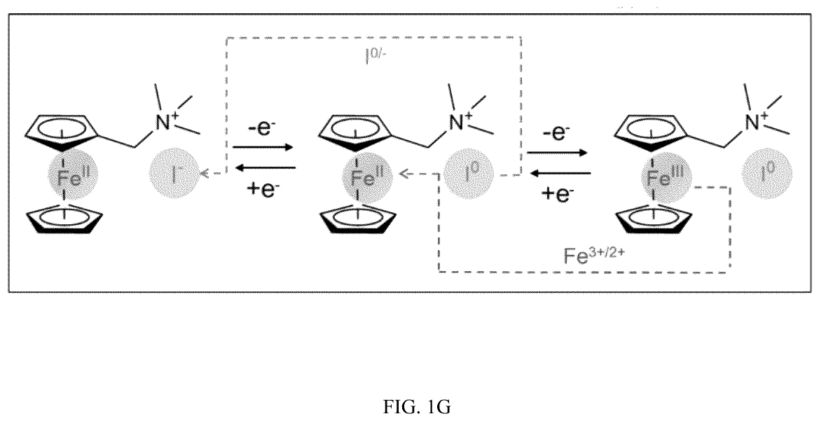

The synthetic scheme of (ferrocenylmethyl) trimethylammonium iodide (FcNI) is illustrated in FIG. 1A. The aminomethylation of ferrocene is firstly conducted to form (ferrocenylmethyl)-dimethylamine (FcN). FcN is further subjected to undergo an alkylation treatment with CH₃I to generate FcNI.

In one embodiment, bis(dimethylamino)methane is added dropwise to a solution of phosphoric acid in glacial acetic acid at 0° C. under N₂. The reaction mixture is then warmed to room temperature and ferrocene is added and the mixture is stirred at reflux for 5 h. The reaction mixture is then diluted with water and separated with ethyl acetate. The organics are then extracted with 1M HCl. The aqueous extracts are basified to pH 10-12 with 4 M NaOH and subsequently extracted with ethyl acetate two times. The combined organics are washed with brine, dried with Na₂SO₄ and the solvent removed in vacuo. The crude product is purified with column chromatography (2% MeOH, 5% Et₃N in ethyl acetate) to yield FcN, appeared as an orange oil.

The obtained FcN is dissolved in 5 mL diethyl ether. To this solution, methyl iodide is added dropwise at room temperature. Then the mixture is stirred for 2 h. The orange precipitate is filtered and washed twice with 20 mL diethyl ether. The final yellow powder is dried under vacuum to collect the final product, FcNI.

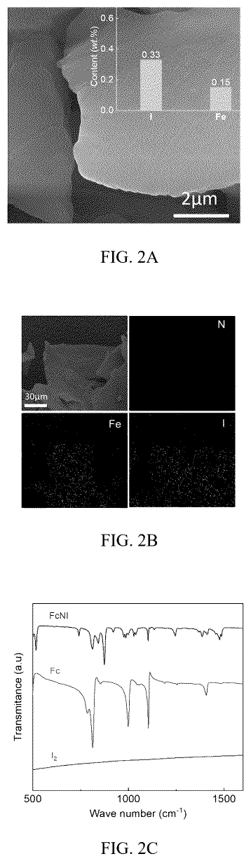

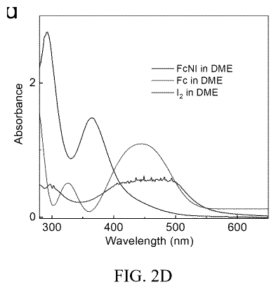

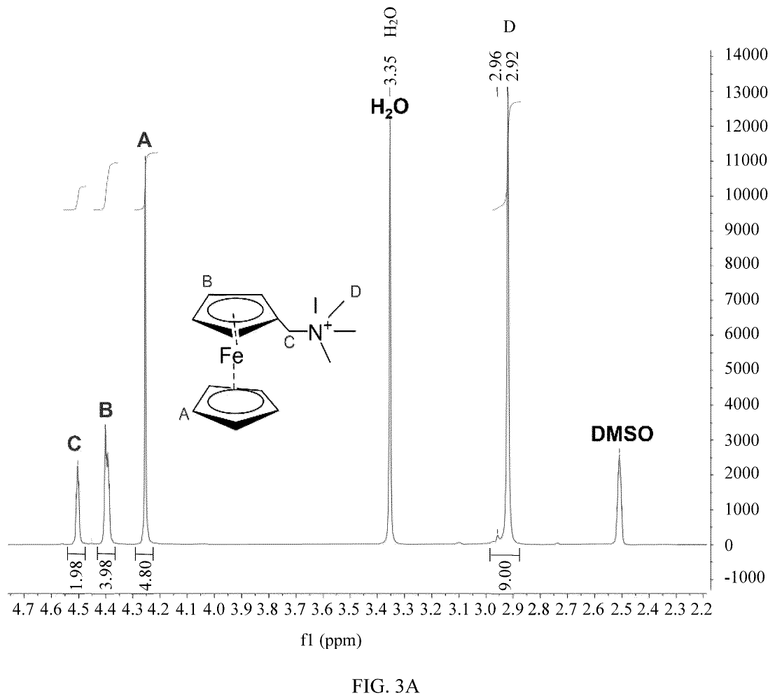

The FcNI is in the form of a yellow powder, characterized by a flaky solid structure with a smooth surface, as revealed in the scanning electron microscopy (SEM) images presented in FIG. 2A and FIG. 2B. The distinctive features of FcNI are further highlighted in the Fourier transform infrared (FTIR) and UV-vis absorption spectra, showcased in FIG. 2C and FIG. 2D, respectively, revealing characteristic peaks specific to FcNI. Notably, the incorporation of the methyltrimethylammonium iodide group to activate the Fe²⁺ redox site, along with the inclusion of ionically bonded I⁻ as an electroactive unit, contributes to FcNI exhibiting multiple electron centers, resulting in a high specific capacity.

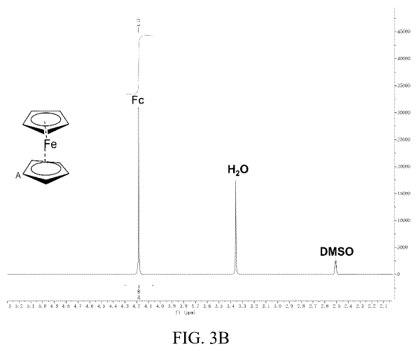

The molecular architecture of FcNI is further elucidated using ¹H nuclear magnetic resonance (NMR) spectroscopy, revealing the presence of four distinct types of protons (A:B:C:D in a ratio of 5:4:2:9). This pattern aligns with the proposed molecular structure of FcNI illustrated in FIG. 1B. In addition, thermogravimetric analysis highlights the enhanced thermal stability of FcNI, with an onset temperature for weight loss surpassing 200° C. (FIG. 3A), in stark contrast to Fe, which undergoes decomposition at temperatures below 80° C. (FIG. 3B). These findings underscore the substantial impact of the side chain on the electronic structure of Fc. As depicted in FIG. 1C showing the molecular structure of FcNI with dual active center (Fe, I), and interaction between the active sites, it is inferred that the substituent group finely tunes the electronic structure of the Fc backbone through their interaction, potentially leading to novel and distinctive electrochemical behaviors.

For calculating and recording the electrochemical measurements of the batteries and/or electrodes, the following will further detail the testing methods.

Briefly, the CR2032 coin-type battery with the polypropylene/polyethylene/polypropylene (PP/PE/PP) three-layer separator (Celgard 2325) is assembled for electrochemical measurements. Galvanostatic charge/discharge profiles are recorded by LAND CT2001A battery testing device. CHI 760E multichannel electrochemical workstation is employed to record the cyclic voltammetry (CV) and electrochemical impedance spectroscopy (EIS) data. The specific gravimetric energy densities (E) of the full cells are calculated by the equation as follows:

$$E Wh {kg}^{- 1} = \int V ∨ dCmAh {g}^{- 1}$$

For kinetics analysis, the current, i, dependence on the sweep rate, v, is given by the relation:

$$i = a {v}^{b}$$

A b value of 0.5 indicates that the current is controlled by semi-infinite diffusion, while b=1 indicates capacitive behavior. b belongs to 0.5-1 indicates a hybrid control. Using an analysis where the current response, i, is a combination of capacitor-like and diffusion-controlled behaviors:

$$i = {k}_{1} v + {k}_{2} {v}^{1 / 2}$$

By determining both k₁ and k₂, it is possible to calculate, as a function of potential, the fraction of current contributed by diffusion-controlled intercalation processes and those arising from capacitor-like processes.

To assess the redox characteristics of FcNI, the energy levels of the lowest unoccupied molecular orbital (LUMO) and the highest occupied molecular orbital (HOMO) are calculated through first-principles density-functional theory (DFT). Briefly, all the computations are conducted based on the density functional theory (DFT) using the Cambridge Sequential Total Energy Package (CASTEP) code of the Materials Studio software. The generalized gradient approximation (GGA) with the Perdew-Burke-Ernzerhof (PBE) functional is used to describe the electronic exchange and correlation effects. The kinetic-energy cutoff is set as 500 eV. The geometry optimization within the conjugate gradient method is performed with forces on each atom less than 0.05 eV/A. Additionally, the converge thresholds for energy and force are set to 10⁻⁵ eV and 0.02 eV/A, respectively. Brillouin zone is sampled by a y a k-point mesh of 1×1×1. The Gibbs free energy change (ΔG) of intermediates is computed to predict the reaction path. The ΔG is calculated as:

$$Δ G = E ( gse ) + E ( zpe ) - T Δ S$$

where E(gse), E(zpe) and TAS are the ground-state energy, zero-point energy and entropy term, respectively, with the latter two taking vibration frequencies from the density functional theory (DFT) calculation.

T is set to 298.15 K. The free energy (ΔG) of different products is also defined as:

$$Δ G = E ( product ) - E ( reactant )$$

where the E(product) is the energy of product in each step and E(reactant) is the total energy of reactants FcNI at the oxidation state.

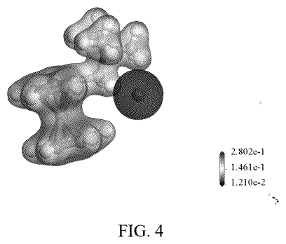

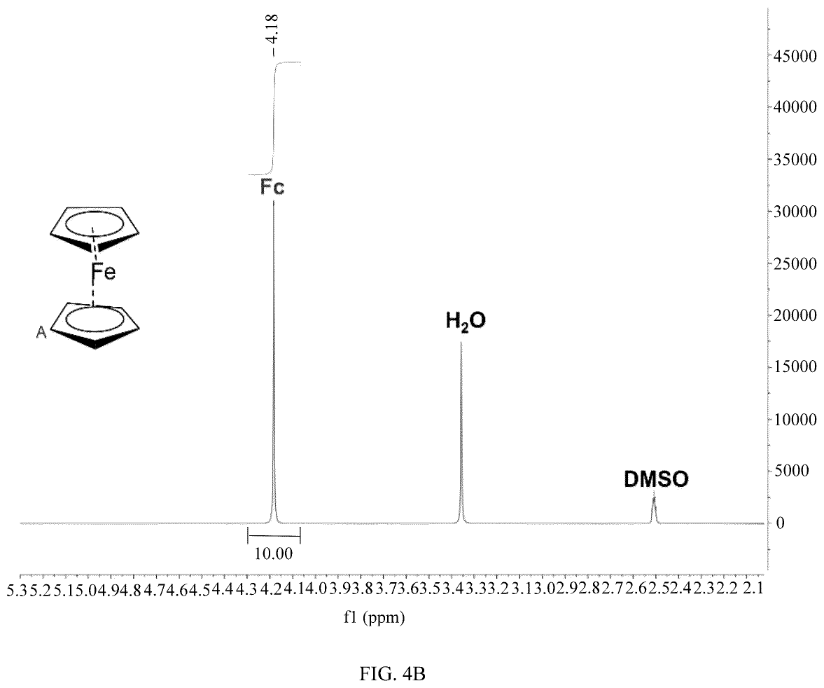

As depicted in FIG. 1D, the LUMO of FcNI (−1.83 eV) is lower than that of Fc (−1.43 eV), indicating heightened electron affinities and superior reduction potentials for FcNI compared to Fc. Furthermore, the gaps between the HOMO and LUMO levels are significantly reduced. The energy gap of FcNI (2.06 eV) is lower than that of Fc (2.84 eV), suggesting enhanced intrinsic electronic conductivity in FcNI compared to Fc. Calculations of the Gibbs free energy (ΔG) for the two-electron transfer process are presented in FIG. 1E, offering theoretical insights into the reaction pathway from a thermodynamic perspective. The initial step could involve the reduction of either Fe³⁺ or I⁰, with Fe³⁺ reduction being more probable due to its larger ΔG (−6.62 eV) compared to I⁰ reduction. Notably, the ΔG for Fe³⁺ reduction in FcNI is also larger than that in Fc (−5.77 eV), predicting a shifted redox potential as the potential correlates directly with ΔG. Subsequently, a substantial ΔG value (−4.64 eV) from I⁰ to I⁻ reduction in FcNI implies a distinct and significant second reduction plateau during the discharging process. The balanced electrostatic potential of FcNI (FIG. 1F and FIG. 4) reveals the evolution of its electronic properties following substitution. Based on this analysis, FIG. 1G schematically illustrates the predicted structural evolution of FcNI during the discharge process. The initial step is anticipated to involve the reduction of Fe³⁺ to Fe²⁺ on the cyclopentadienyl ring, followed by the second step of I⁰ reduction on the organic groups.

To scrutinize the distinctive electrochemical attributes of FcNI, characterized by multiple redox reactions and significantly enhanced voltage, a zinc (Zn) battery is employed as a model system for study.

In one embodiment, for FcNI cathode, FcNI powder, ketjenblack (KB), and PVDF are mixed in N-Methylpyrrolidone solvent with a mass ratio of 7:2:1, followed by vigorously stirring for 20 minutes. Then, the slurry is coated on a flexible carbon cloth. The cathode is obtained after drying at 50° C. in a vacuum oven for 24 h. Zn foil is used as an anode electrode. The electrolyte is fabricated by dissolving 1 M lithium ZnTFSI salts into the DME solvents.

For comparisons, the I₂ and Fc electrodes are also fabricated. Briefly, YP50 disks are prepared by mixing YP50 powder, KB, and PVDF in N-methylpyrrolidone solvent with a mass ratio of 5:2:1, followed by vigorously stirring for 20 minutes. Next, the slurry is coated on a titanium foil and dried at 70° C. in a vacuum oven for 24 h. Then YP50 disks and I₂ or Fc are put into a stainless reactor. The reactor us then sealed and heated to 70° C. for 12 h. I₂ or Fc loading (˜50 wt %) is measured by subtracting the mass of pure YP50 from the YP50 with I₂ loading.

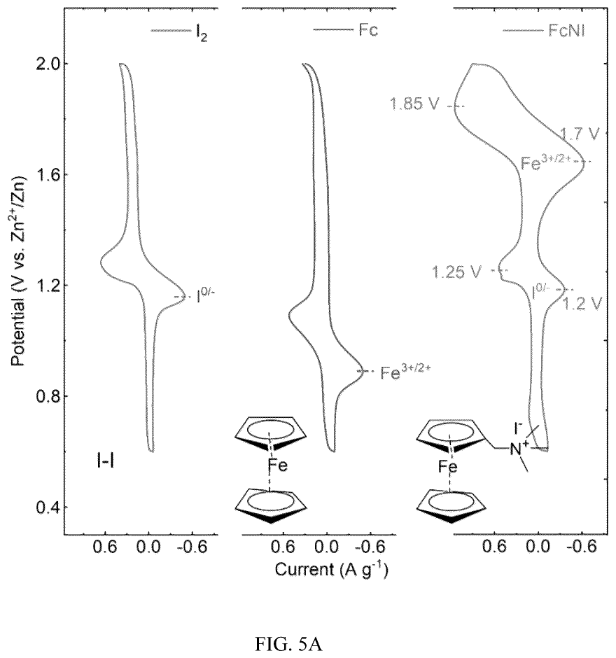

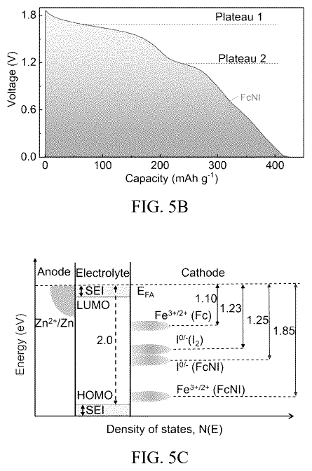

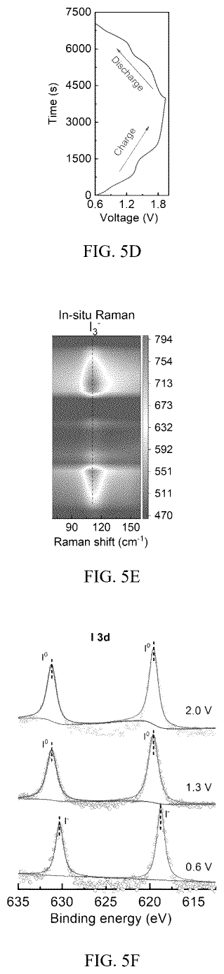

Illustrated in FIG. 5A, cyclic voltammetry (CV) curves (recorded by CHI 760E multichannel electrochemical workstation) of FcNI reveal two pairs of cathodic peaks at approximately 1.2 V and 1.7 V vs Zn²⁺/Zn. Firstly, in contrast to the cathodic peak of Fc at 0.9 V and 12 at 1.15 V, the remarkably high discharge voltage of FcNI is attributed to the activated Fe^{3+/2+} redox, exhibiting a substantial increase of 0.8 V. This is a result of the adjusted redox potential of Fe^{3+/2+} facilitated by electron regulation. Additionally, the polarization of I^{0/-} redox in FcNI decreases by 0.05 V compared to I₂. Secondly, the redox activity of Fe^{3+/2+} in FcNI is significantly enhanced, evident from a large-area CV peak at 1.7 V, while a relatively small peak is observed in the CV curve of Fc. These outcomes stem from the meticulous selection of a substituent group and effective electron tuning, as analyzed in FIG. 1. The galvanostatic discharge profile (recorded by LAND CT2001A battery testing device) of a Zn-FcNI battery, depicted in FIG. 5B, exhibits two plateaus at 1.2 and 1.7 V, aligning with the two cathodic peaks observed during the CV scan. FIG. 5C delves into the electronic density of states and Fermi energies for a cathode electrode. A comparison of the Fe³⁺/Fe²⁺ redox couple for FeNI (1.85 eV) and Fc (1.05 eV), in conjunction with the I⁰/I⁻ redox couple for FeNI (1.25 eV) and I₂ (1.23 eV), underscores the role of side chain regulation in drastically shifting the redox energy of the Fe^{3+/2+} couple by altering characteristics of the Fe-benzene ring bond.

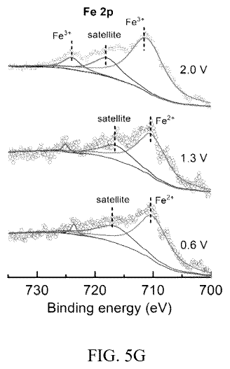

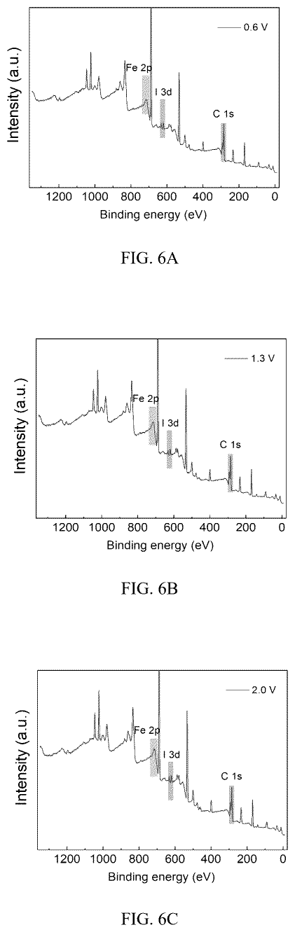

The redox processes occurring during charge storage are examined through in-situ Raman and ex-situ X-ray photoelectron spectroscopy (XPS) of polarized electrodes at varying voltages. As shown in FIG. 5D and FIG. 5E, the I₃⁻ stretching band at 110 cm⁻¹ is recorded during the charging/discharging measurement at a current density of 0.3 A g⁻¹. Notably, during the charging process, I₃⁻ species are detected after the voltage reaches 1.2 V. Consequently, the first plateau at the voltage of 1.2 V is attributed to the oxidation of I⁻ to I⁰. The disappearance of intermediates I₃⁻ species when the voltage exceeds 1.3 V indicates the completion of the I^{0/1-} redox. To further elucidate the structural evolution during the battery process, XPS analyses are performed to monitor the valence state changes of Fe and I at different voltages (FIG. 5F and FIG. 5G). The XPS survey spectra of the electrodes after the electrochemical test at 0.6 V, 1.3 V and 2.0 V are depicted in FIGS. 6A-6C, where Fe, I and C peaks are identified. Upon charging to 1.3 V, neutral I valance states are observed, and their position (I3d_{3/2} at 631.2 eV and I3d_{5/2} at 619.6 eV) remain stable in the subsequent charge process (FIG. 5F). This observation that I exist in a neutral valence state aligns with the Raman spectra interpretation, suggesting that the initial plateau can be attributed to the oxidation of I⁻ species. The iron environments at different polarized are also examined by XPS (FIG. 5G). Fe 2p_{3/2} peaks at 710.3 eV, assigned to Fe (II) formal oxidation states before 1.3V, exhibits a 1.3 eV shift to higher energy at 11.6 eV as charging continues, and a distinct Fe²p_{1/2} peak at 724.0 eV is observed, both indicative of Fe (III). These results suggest the occurrence of the Fe^{3+/2+} redox reaction during the second plateau. In summary, Raman and XPS spectra contribute to identifying structural changes associated with multiple electron transfer during battery operations.

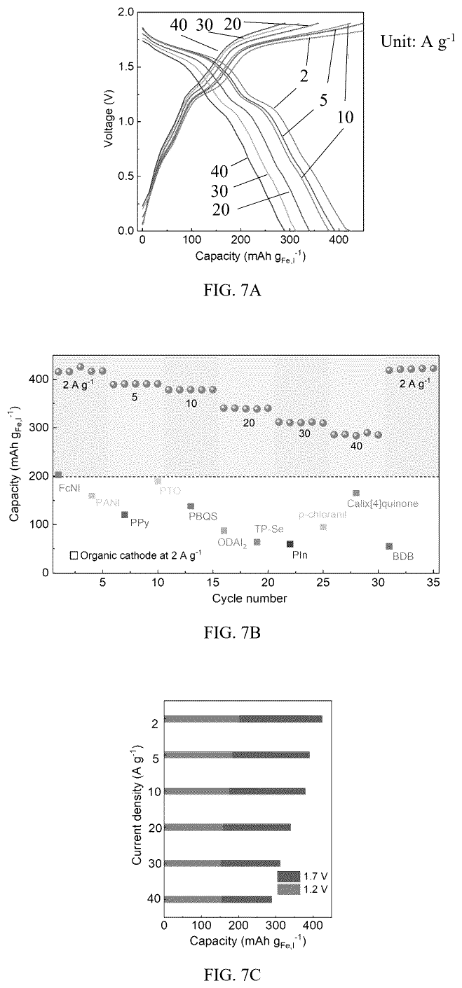

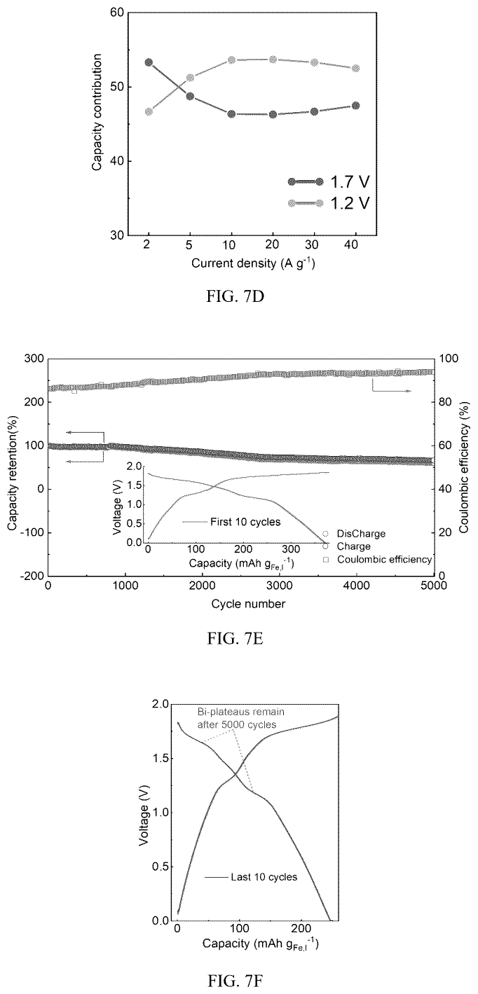

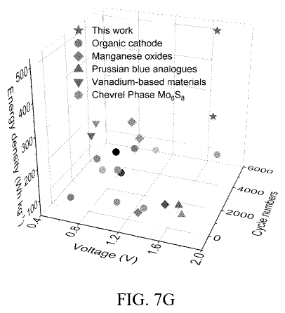

The electrochemical properties of FcNI are further systematically evaluated using metal Zn as the counter electrode. FIG. 7A shows the galvanostatic charge-discharge profiles of Zn-FcNI full cell at different current densities from 2 to 40 A g⁻¹, displaying two characteristic discharge plateaus at 1.2 and 1.7 V observable at all current densities. At a current density of 2 A g⁻¹, an ultra-high specific capacity of 421 mAh g_{Fe, I}⁻¹ (202 mAh g_{FcNI}⁻¹, Figure S9) is achieved. It is among the highest reported thus far for Zn-organic batteries (based on mass of cathode materials at a current density of 2 A g⁻¹ with reported organic cathodes, including polyaniline (PANI), polypyrrole (PPy), pyrene-4,5,9,10-tetraone (PTO), poly(benzoquinonyl sulfide)(PBQS), triphenylphosphine selenide organic cathode (TP-Se), 1,8-octanediamine iodide (ODAI₂), polyindole (PIn), tetrachloro-1,4-benzoquinone (p-chloranil), 1,4 bis(diphenylamino) benzene (BDB)) at the same current density (FIG. 7B) and dramatically exceeds the voltage of PTO (0.8 V) with the second highest capacity. Besides, the FcNI-based cell exhibits excellent rate performance. Even at a high loading current density of 40 A g⁻¹, the Zn-FcNI battery can still render a capacity of 286 mAh g⁻¹, which corresponds to 69% of the initial specific capacity (FIG. 7B). Furthermore, the rate capability curves are highly reversible when the cycles are carried out at 2 A g⁻¹ again. FIG. 7C and FIG. 7D compare the capacity contributions of two discharge plateaus at different current densities. A minor fluctuation of capacity contribution from two plateaus is observed as the current density increases, attested to fast charge transfer kinetics of Fe and I redox centers.

The cycling performance of the Zn-FcNI cell is evaluated (FIGS. 7E-7G). The specific gravimetric energy densities of the full cell are calculated by integral area of voltage vs. capacity by definition, estimated to be ˜250 Wh kg_{FcNI}⁻¹ (516.8 Wh kg_{Fe,I}⁻¹ based on mass of active centers, FIG. 7E) at 2500 W kg⁻¹, higher than that of reported organic cathodes such as PANI and Calix[4]quinone. It can still deliver capacities of ˜155 Wh kg_{FcN}⁻¹, affording a very high-power density of ˜45,000 W kg_{FcNI}⁻¹. Moreover, when comparing the performance of the FcNI electrode to other reported cathode materials (FIG. 7E), it stands out among them (cathodes organic cathodes, manganese oxides, Prussian blue analogues, vanadium-based materials, chevrel phase Mo₆S₈) in a comprehensive evaluation considering voltage, cycling number and energy density. Specially, it delivers a reversible capacity of 372 mAh g⁻¹ in the first 10 cycles, as shown in the inset of FIG. 7F, while maintaining around 247 mAh g⁻¹ after 5000 cycles under a current density of 5 A g⁻¹, demonstrating high-capacity retention of ˜66% after 5000 cycles (FIG. 7F and FIG. 7G). More importantly, the bi-plateau feature from I^{0/-} and Fe^{3+/2+} redox is remained during the whole cycling (FIG. 7G).

Furthermore, by pairing a FcNI positive electrode with a Li metal anode, rechargeable lithium (Li) batteries are evaluated. For Li-FcNI cell assembly, the cathode fabrication is same as the aforementioned, but anode electrode is utilized Li foil. The electrolyte is fabricated by dissolving 1 M lithium salts LiTFSI into the mixture of DOL and DME solvents with a volume ratio of 1:1 in a glove box filled with Ar atmosphere.

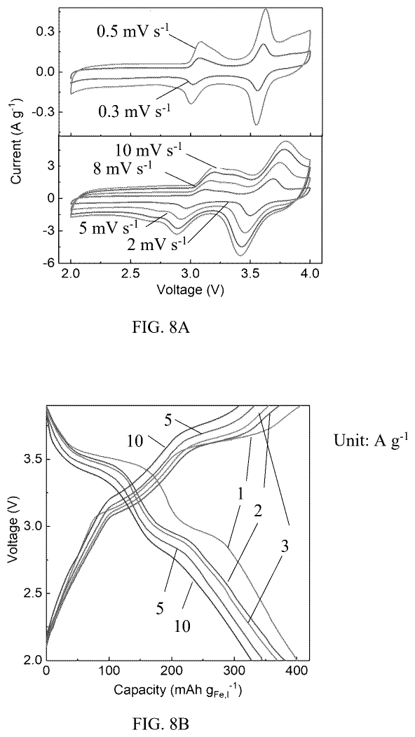

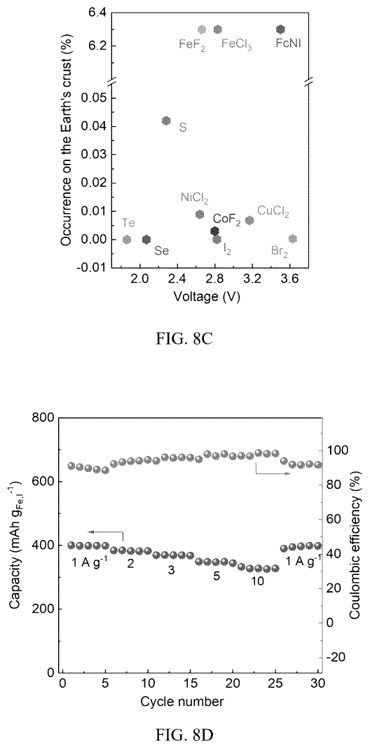

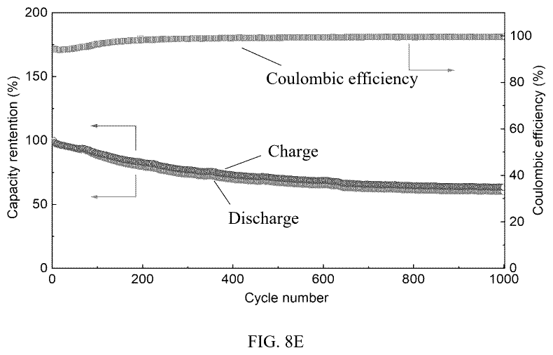

As shown in FIG. 8A, The CV demonstrates two clear reduction peaks at 3.0 V (I^{0/-1} redox) and 3.5 V (Fe^{3+/2+} redox) during cathodic CV scans, corresponding to two pairs of reversible plateaus at corresponding voltages during galvanostatic charge/discharge curves of a Li-FcNI cell. The CV and galvanostatic charge/discharge characteristics of Li-FcNI clearly point to high-voltage multiple redox reactions and the highly reversible nature of these electrodes. The maximum working voltage of the FcNI battery is about 3.5 V (FIG. 8C), much higher than the S (2.2 V), Se (2.1 V), Te (1.8 V) based batteries and other Fe-based batteries such as FeF₂ (2.6 V), FeCl₃ (2.8 V). Besides the improved voltage against conversion-type Li batteries, the FcNI demonstrates superior occurrence on Earth' crust in terms of main elements. Furthermore, owing to the multi-electron transfer, the capacity of FcNI is higher than that of one-electron-transfer-based batteries.

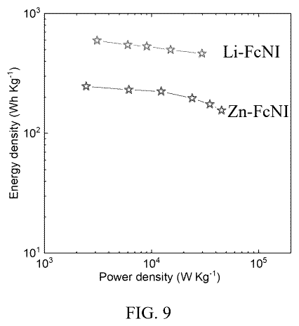

The rate capabilities of Li-FcNI are also investigated. The Li-FcNI battery shows stable reversible capacities of 400, 384, 370 and 349 mAh_{Fe, I} g⁻¹ at current densities of 1, 2, 3, and 5 A g⁻¹, respectively. Even at a high loading current of 10 A g⁻¹, the FcNI battery can still render a capacity of 327 mAh g⁻¹, which corresponds to 82% of the initial specific capacity (FIG. 8D). Benefitting from the high voltage output and capacity, it achieves a maximum energy density of 595 Wh kg_{FcNI}⁻¹ and reaches 463 Wh kg_{FcNI}⁻¹ at a high-power density of 30000 W kg_{FcNI}⁻¹ (FIG. 9). In addition, the cycling performance of the Li-FcNI cell is evaluated, and it delivers a high-capacity retention of ˜64% after 1000 cycles under a current of 1 A g⁻¹ (FIG. 8E). These results further confirm the high-voltage, high-rate, multi-electron transfer chemistry of ferrocene derivatives is highly effective for the fabrication of high-performance cathodes in various batteries.

The fundamental mechanisms responsible for charge storage kinetics of the FcNI cathode is further examined using electrochemical characterization are further investigated.

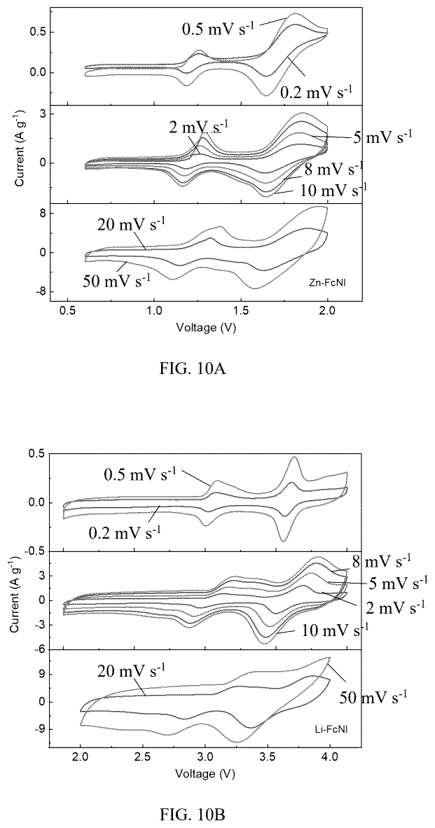

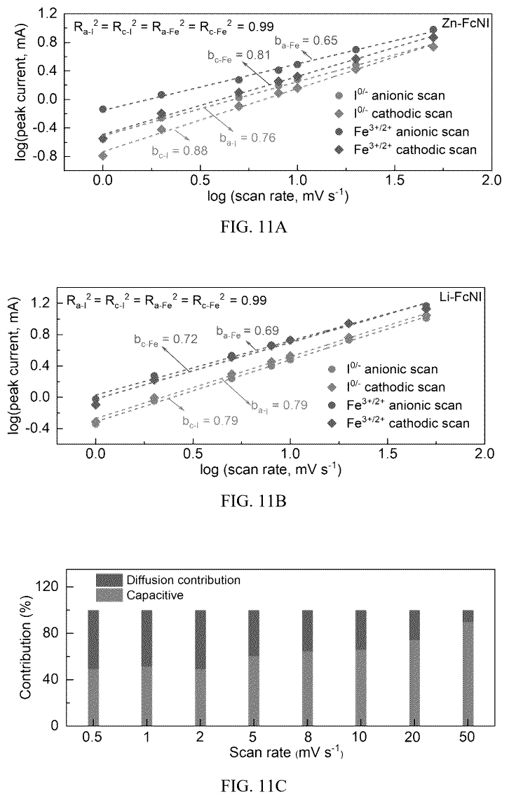

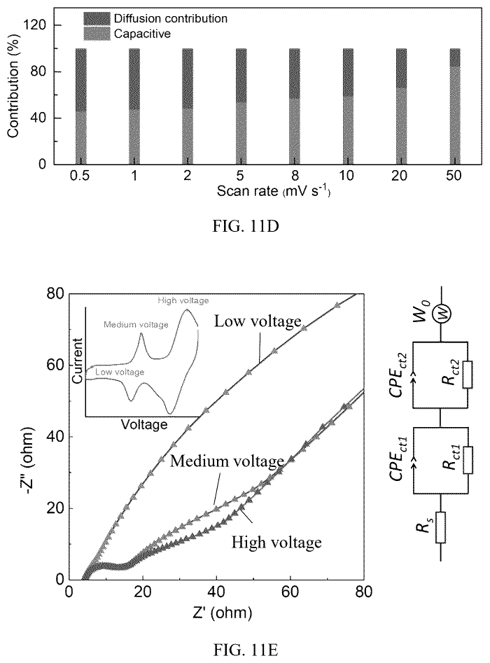

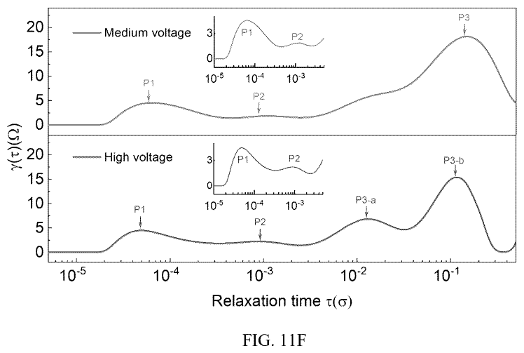

Cyclic voltammetry curves of FcNI at various scan rates (0.2-50 mV s⁻¹) show two cathodic and anodic peaks in good agreement with the two plateaus observed in Zn (FIG. 10A) or Li (FIG. 10B) batteries during charging/discharging. Two pairs of peaks are exhibited throughout a wide scan range, and the potential polarization (a gap between reduction and oxidation potential) increased slightly as the sweeping rate climbed, indicating a fast kinetics and excellent rate performance. In FIG. 11A and FIG. 11B, the log (peak current) versus log (scan rate) plots for the anionic and cathodic peaks at 1.2 V (I redox) and 1.7 V (Fe redox versus Zn/Zn²⁺) or at 3.0 V (I redox) and 3.5 V (Fe redox versus Li/Li⁺) shows good linearity (R-squared close to 1) even at high scan rate of 50 mV s⁻¹, further confirming a good rate performance. The b values are calculated to be 0.88 and 0.81 for I/and Fe^{3+/2+} cathodic peaks in a Zn-FcNI cell (0.79 and 0.72 in for Li-FcNI cell), respectively, meaning that the charge storage is affected by diffusion and capacitive processes simultaneously. The anodic peaks for both redox reactions show the same general behavior. To separate the diffusion-controlled capacity and capacitive capacity, the contribution ratios at different scan rates are calculated (FIG. 11C and FIG. 11D). It is found that the capacitive process contributes about 45% of the total capacity at 0.5 mV s⁻¹, and its capacitive contribution ratio gradually increases as the scanning speed increases, reaching higher than 80% at 50 mV s⁻¹, which brings about a high-rate performance.

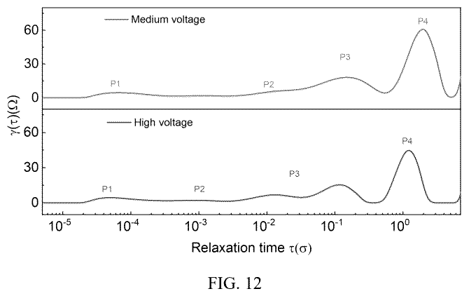

Moreover, the redox reaction kinetics are evaluated by electrochemical impedance spectroscopy (EIS, recorded by CHI 760E multichannel electrochemical workstation) surveyed at different voltages from low to medium to high values (FIG. 11E). First, the intersection points of Nyquist plots with the X-axis represent Rs. In the high-frequency region, the Nyquist plot at a low voltage (where no redox reaction occurs) underscores a capacitive nature since no semicircle part (charge transfer resistance, R_{ct}) is observed. One semicircle occurs at a medium voltage where I^{0/-} redox starts, and two semicircles arise at a high voltage, corresponding to the right equivalent circuit model with R_{ct1} and R_{ct2} from two charge transfer reactions of I^{0/-} and Fe^{3+/2+}. Three curves in the lower frequency region show a similar slope, suggesting a similar Warburg impedance derived from ion diffusion. However, reaction processes are inevitably overlapped in Nyquist plots. To clearly differentiate the reaction steps, impedance spectra were analyzed by a distribution of relaxation times (DRT) technique. FIG. 11F presents plots of the DRT function (γ(τ)) vs. relaxation time (τ). Three characteristic peaks of reaction processes (P1, P2, and P3) are identified in the T range of 10⁰ to 10⁻⁶ s. Peak P3 at the medium voltage is attributed to the charge-transfer reaction, and two peaks (P3-a and P3-b) appear at the high voltage because two redox centers are activated at this point. Peaks P1 and P2 at shorter relaxation times are ascribed to interfacial reactions, including desolvation and ion transport across the cathode-electrolyte interphase. The peak at τ>10⁰ s corresponds to ion diffusion in bulk electrode, related to Warburg diffusion (FIG. 12). Notably, the γ(τ) peaks of P3-a assigned to Fe^{3+/2+} redox appeared at shorter τ values than P3-b or P3 assigned to I^{0/-}, which suggested a faster electrochemical response.

In summary, the present invention promotes the energy storage performance of ferrocene backbones by incorporating a redox-active group to achieve multi-electron transfer chemistry. The FcNI design maximizes the tunability of organic molecules, allowing for adjustment of capacity, voltage, conductivity, and redox kinetics for electrode materials. Firstly, the meticulously designed functional groups highly facilitate the redox activity of Fe^{3+/2+} and simultaneously act as active redox centers, enabling a multiple electron transfer and thus yielding high capacity. Secondly, the discharging plateau of Fe³⁺²⁺ is activated to 1.7 V vs. Zn/Zn²⁺ or 3.5 V vs. Li/Li⁺ due to electronic cloud interaction between two active centers, which regulates the electron energy related to the redox potential of Fe. Thirdly, both the I^{0/-} and activated high-voltage Fe^{3+/2+} redox feature intrinsically fast kinetics for a high-power cathode. The rechargeable Zn/Li-FcNI cells demonstrate excellent reversibility over thousands of cycles, delivering a capacity of over 400 mAh g_{Fe, I}⁻¹ (˜200 mAh g_{FcNI}⁻¹). The energy densities of Zn-FcNI and Li-FcNI can reach 250 and 595 Wh kg⁻¹ based on the mass of FcNI, and energy densities of 155 and 463 Wh kg⁻¹ remain at a high power of 45000 W and 300000 W, respectively.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A high-voltage, high-power battery, comprising:
at least one anode comprising one or more materials selected from lithium metal or zinc metal;
at least one organic cathode comprising an active material comprising a (ferrocenylmethyl) trimethylammonium iodide (FcNI) with formula (1): 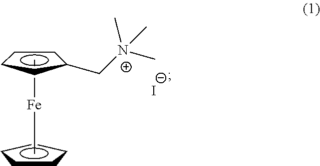
at least one porous polymer separator having a porosity from approximately 30% to 90%; and
an ether electrocyte.

2. The battery of claim 1, wherein the FcNI is a ferrocene backbone introduced with methyltrimethylammonium iodide groups.

3. The battery of claim 1, wherein the introduced methyltrimethylammonium iodide groups enhances the redox activity of Fe^{3+/2+} and acts as active dual-redox centers for multiple electron transfer.

4. The battery of claim 3, wherein Fe^{3+/2+}'s discharging plateau is increased with 0.5-1.0 V by introducing the methyltrimethylammonium iodide groups, which regulates the electron energy of the redox potential of Fe.

5. The battery of claim 1, wherein the battery has a maximum working voltage of 3.5V when the at least one anode comprising Li metal material.

6. The battery of claim 1, wherein the battery has a maximum working voltage of 1.7V when the at least one anode comprising Zn metal material.

7. The battery of claim 2, wherein the at least one organic cathode is prepared by mixing the FcNI, an electrically conductive particle and a binder in a solvent to obtain a mixture, and coating the mixture on a current collector with a subsequent drying process conducted at 40-70° C. in a vacuum oven for at least 24 hours.

8. The battery of claim 7, wherein the current collector is selected from a carbon cloth, a carbon paper, a graphite paper, a Ti foil/mesh, or a stainless steel stabled with high-valence-state chlorine.

9. The battery of claim 7, wherein the solvent is selected from monoglyme, diglyme, triglyme, or tetraglyme.

10. The battery of claim 7, wherein the electrically conductive particle is selected from a reduced graphene oxide, an activated carbon, a hollow carbon sphere, or a carbon cloth.

11. The battery of claim 7, wherein the binder is selected from styrene-butadiene rubber (SBR) or polyvinylidene fluoride (PVDF).

12. The battery of claim 1, wherein the ether electrocyte is an ether solvent with or without an additive.

13. The battery of claim 12, wherein the ether solvent is selected from monoglyme, diglyme, triglyme, tetraglyme, or a combination thereof in a volume ratio of 1:1/1:2/1:3/1:4.

14. The battery of claim 12, wherein the additive is selected from saccharin, vanillin, sorbitol, or aromatic analogs.

15. The battery of claim 14, wherein the additive comprises C═O, —F, —O— or —SO3 radicals when the at least one anode comprising Zn metal material; and the additive comprises LiF, LiNO3, vinylene carbonate (VC), vinyl ethylene carbonate, allyl ethyl carbonate, or lithium bis(oxalato) borate when the at least one anode comprising Li metal material.

16. The battery of claim 12, wherein the ether electrocyte comprises Zn/Li salts.

17. The battery of claim 16, wherein the Zn salts are selected from Zn(TFSI)₂, Zn(FSI)₂, Zn(OTF)₂, Zn(ClO₄)₂, ZnAc₂, ZnCl₂, or Zn(PF₆)₂.

18. The battery of claim 16, wherein the Li salts are selected from LiTFSI, LiOTF, LiPF₆, LiClO₄, LiBF₄, LiAsF₆, LiDFOB.
